(19) United States
(12) Patent Application Publication
(10) Pub. No.: US 2005/0107123 A1
(43) Pub. Date: May 19, 2005

(54) Base transceiver station and resource rearrangement method

(75) Inventors: Hidenori Ishii, Tokyo (JP); Kenji Takagi, Yokohama-shi (JP); Go Nakano, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/967,230

(22) Filed: Oct. 19, 2004

(30) Foreign Application Priority Data
Nov. 14, 2003 (JP) 2003-384721

(51) Int. Cl. H04M 1/00

(52) U.S. Cl. 455/560

(57) ABSTRACT

A base transceiver station enabling increases in the number of calls that can be accommodated at the same time. In the apparatus, each of signal processing cards 103-1 to 103-M has a predetermined number of resources to perform baseband processing on a call. Group creating section 108 compares the number of required resources of a call with a predetermined number, and sorts the call to a group corresponding to a result of the comparison. Resource control section 104 allocates a call to connect to either of signal processing cards 103-1 to 103-M. Further, resource control section 104 reallocates the call to another signal processing card of signal processing cards 103-1 to 103-M, according to the group to which the call, allocated to either of signal processing cards 103-1 to 103-M, is sorted.

### BACKGROUND OF THE INVENTION

1. Field of the Invention

The present invention relates to a base transceiver station enabling wireless communications with a plurality of terminal apparatuses and a resource rearrangement method applied to the base transceiver station.

2. Description of Related Art

In recent years, the popularization of cellular telephones has been remarkable, and services of cellular telephones in W-CDMA (Wideband-Code Division Multiple Access) standards first started in Japan in 2001. With respect to communication techniques, while only speech communications and low-rate packet communications have been available previously, the introduction of W-CDMA has enabled wideband transmission, for example, services of 384 kbs started in 2002.

A general network system applying W-CDMA is comprised of an exchange, RNC (Radio Network Controller), BTS (Base Transceiver Station), etc. In the network system, the base transceiver station performs radio communications with terminal apparatuses, for example, cellular telephones, and converts radio signals into baseband signals for the network.

Since various applications are provided utilizing broadband transmission in W-CDMA, calls of high-rate transmission have increased due to video conference, fast packet transmission, etc. among types of traffic occurring in a coverage area of the base transceiver station. In response thereto, it is required to improve the resource management system and efficiently use the accommodation capacity of the base transceiver station.

In addition, the “resource” mentioned hereinafter means a set of hardware elements to which a call is allocated so as to perform predetermined baseband processing on a baseband signal of the call. In other words, the resource conceptually represents the processing capability required for the baseband processing, and it is considered that the degree of processing capability of the baseband processing increases as the number of resources to use is larger. Hereinafter, the degree of the processing capability and the quantity of resource is represented by using an “area” as a unit. As additional information to confirm, the resource is different from the concept of “radio resource” representing strength of a radio signal of a communication channel or the like.

A conventional base transceiver station and resource reallocation method will be described below. FIG. 1 is a block diagram illustrating an example of a configuration of a conventional base transceiver station.

Base transceiver station 10 as shown in FIG. 1 transmits and receives radio signals to/from terminal apparatus 20, while transmitting and receiving baseband signals for wired communications to/from network 30 with the exchange function, to accommodate communication calls for terminal apparatus 20. In addition, in following descriptions, terminal apparatus 20 is assumed to be a 3rd-generation cellular telephone in W-CDMA or MC (Multi-Carrier)-CDMA, but also applicable are portable telephones or cordless telephones in GSM (Global System for Mobile communications), PHS (Personal Handy-phone System), PDC (Personal Digital Cellular) or the like. Further, base transceiver station 10 and network 30 connect to each other in ATM (Asynchronous Transfer Mode) via a dedicated channel.

Base transceiver station 10 has wireless communication section 11, connection control section 12, signal processing section 13, resource control section 14, wired communication section 15 and call type priority determination section 16. Wireless communication section 11 transmits and receives radio signals to/from terminal apparatus 20. Wireless communication section 11 performs transmit power control of an antenna, terminal apparatus 20 and frequency conversion processing and so on. Wireless communication section 11 is provided with the antenna, amplifier, power source for transmission and control program.

Connection control section 12 performs control for connecting and disconnecting a communication path with terminal apparatus 20 in response to a request of network 30. Connection control section 12 is implemented as a program in a control card in base transceiver station 10. Signal processing section 13 performs predetermined baseband processing such as code modulation processing of radio signals from terminal apparatus 20. In order to accommodate a large number of terminal apparatuses 20 at the same time, signal processing section 13 is provided with a large number of (for example, N) signal processing cards 13-1, 13-2, . . . , 13-N of the same system.

Resource control section 14 allocates and deallocates an occurring call to/from either of signal processing cards 13-1 to 13-N in signal processing section 13. Wired communication section 15 transmits and receives signals to/from network 30. Call type priority determination section 16 determines priorities for each call type based on arrival probability and communication quality. The call type herein indicates, for example, speech call, packet call, unrestricted digital information (UDI) call, etc.

W-CDMA enables services of a large number of types of calls such as speech calls, packet calls and UDI calls. The transmission rate and the number of resources required for signal processing cards 13-1 to 13-N to process a call differ with types of calls. For example, a speech call requires one-area resource, a UDI call requires three-area resources, a low-rate packet call requires six-area resources, and a high-rate packet resource requires sixteen-area resources.

Under the environments such that many types of calls with predetermined different numbers of required resources occur and vanish repeatedly, it is demanded of the resource management system to efficiently use limited resources in base transceiver station 10 not to cause call losses as possible.

Generally, under following two premise conditions, there is a defect that small available resources disperse to signal processing cards 13-1 to 13-N and the transmission efficiency deteriorates when a large amount of traffic flows into base transceiver station 10. Herein, an available resource is an unused resource to which a communication channel (call) is not allocated. Further, the dispersion of available resources is called fragmentation or fragment of available resource.

(Condition A1) A communication system (for example, W-CDMA) is used which supports a large number of types of calls where the number of required resources varies with the types of calls.

(Condition A2) There is a restriction that a single call is allocated to a single signal processing card.

Particularly, as in “condition A2”, when the restrict exists that a single call should be allocated to a single signal processing card, a case occurs that a call newly occurring cannot be allocated because the number of available resources of each of signal processing cards 13-1 to 13-N is smaller than the number of required resources of the call, despite the total number of available resources of all signal processing cards 13-1 to 13-N being more than the number of required resources.

For example, when each of two signal processing cards, 13-1 and 13-2, has four-area resources and the other signal processing cards, 13-3 to 13-N, do not have any available resources, the number of available resources of each of signal processing cards 13-1 to 13-N is smaller than the number of required resources (six areas) of a low-rate packet call. Therefore, in such a case, a low-rate packet call is not allocated, despite resources of four times two being eight areas in the entire.

Accordingly, measures are needed against “condition A2” to improve the transmission efficiency. Following two items are considered as the measures.

(Measure C1) Signal processing cards 13-1 to 13-N are provided with functions of synchronization and cooperation among a plurality of signal processing cards to eliminate “condition A2”.

(Measure C2) Allocation destinations (signal processing cards) of part of calls are changed (reallocated) to collect a plurality of small-area available resources. This processing is called rearrangement of resource.

“Measure C1” will be described first. In a design such that baseband processing of a call can be carried out in a plurality of cards at the same time among signal processing cards 13-1 to 13-N (LSI, card), it is necessary to implement functions of synchronization, cooperation and so on among a plurality of signal processing cards, increasing the cost. Particularly, base transceiver station 10 has a large number of baseband processing devices or cards corresponding to signal processing cards 13-1 to 13-N, and increases in cost of signal processing cards 13-1 to 13-N have a significant effect on the entire cost of base transceiver station. Therefore, it is desired to consider another method to improve the transmission efficiency under “condition A2” except the method of improving the function of signal processing cards to avoid the restriction.

Meanwhile, as a resource rearrangement method of “measure C2”, for example, there is a method disclosed in JP2002-505065, page 12 and subsequent pages. The publication mainly shows a scheme to an FDMA (Frequency Division Multiple Access)/TDMA (Time Division Multiple Access) system, and more specifically, shows an algorithm when services extend over a plurality of frequencies or time slots.

In the publication, using the total arrival probability in consideration of inclusive relationship between a plurality of call types, call type priority determination section 16 determines priorities for each call type, and when sufficient available resources do not exist on a signal processing card as an allocation destination, separates a call with a lower priority than that of a new call to generate available resources. It is thus possible to accommodate a call with a high priority, or a call occurring subsequently. In the publication, a call type with a large number of required resources is considered to contain call types with smaller numbers of required resources, probabilities of the call types contained in the call types are summed for each call type to calculate the total arrival probability, and a priority of a call type is increased as its total arrival probability is larger. Accordingly, a call type with a small number of required resources has a small number of contained call types, has a low total arrival probability, and thus has a low priority, while a call type with a large number of required resources has a high priority.

However, in the conventional base transceiver station and resource rearrangement method, since rearrangement is carried out based on only a current state of available resource, there is a possibility that a part of types of calls cannot be accommodated for a long period when the part of types of calls such as a high-rate packet call newly occurs and only available resources occur which are smaller than a number of required resources of the part of types of calls. This is because the number of available resources does not increase unless the traffic decreases. In other words, fragments tends to occur, and it is not easy to improve the use efficiency of resources of signal processing cards and suppress occurrences of call loss. Accordingly, there has been a problem that certain limitations exist in increases in the number of calls that can be accommodated at the same time.

### SUMMARY OF THE INVENTION

It is an object of the present invention to provide a base transceiver station and resource rearrangement method enabling increases in the number of calls that can be accommodated at the same time. In the present invention, the object is achieved by comparing the number of required resources of a call with a predetermined value, sorting the call into a group corresponding to a result of the comparison, and reallocating the call allocated to a single signal processing section to another signal processing section of a plurality of signal processing sections, according to a group to which the call is sorted which is allocated to the single signal processing section among the plurality of signal processing sections each having a predetermined number of resources to perform predetermined signal processing.

According to an aspect of the invention, a base transceiver station has a plurality of signal processors each having a predetermined number of resources to perform predetermined signal processing on a call, a sorter which compares the number of required resources of a call with a predetermined value, and sorts the call to a group corresponding to a result of the comparison, and an allocating section that allocates a call to connect to a single signal processor among the plurality of signal processors, where the allocating section reallocates the call to another signal processor of the plurality of signal processors according to the group to which the call is sorted that is allocated to the single signal processor.

According to another aspect of the invention, a resource rearrangement method is a resource rearrangement method in a base transceiver station having a plurality of signal processors each having a predetermined number of resources to perform predetermined signal processing on a call, and has a sorting step of comparing the number of required resources of a call with a predetermined value, and sorting the call to a group corresponding to a result of the comparison, an allocating step of allocating a call to connect to a single signal processor among the plurality of signal processors, and a reallocating step of reallocating the call to another signal processor of the plurality of signal processors according to the group to which the call, which is allocated to the single signal processor in the allocating step, is sorted in the sorting step.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a block diagram illustrating an example of a configuration of a conventional base transceiver station;

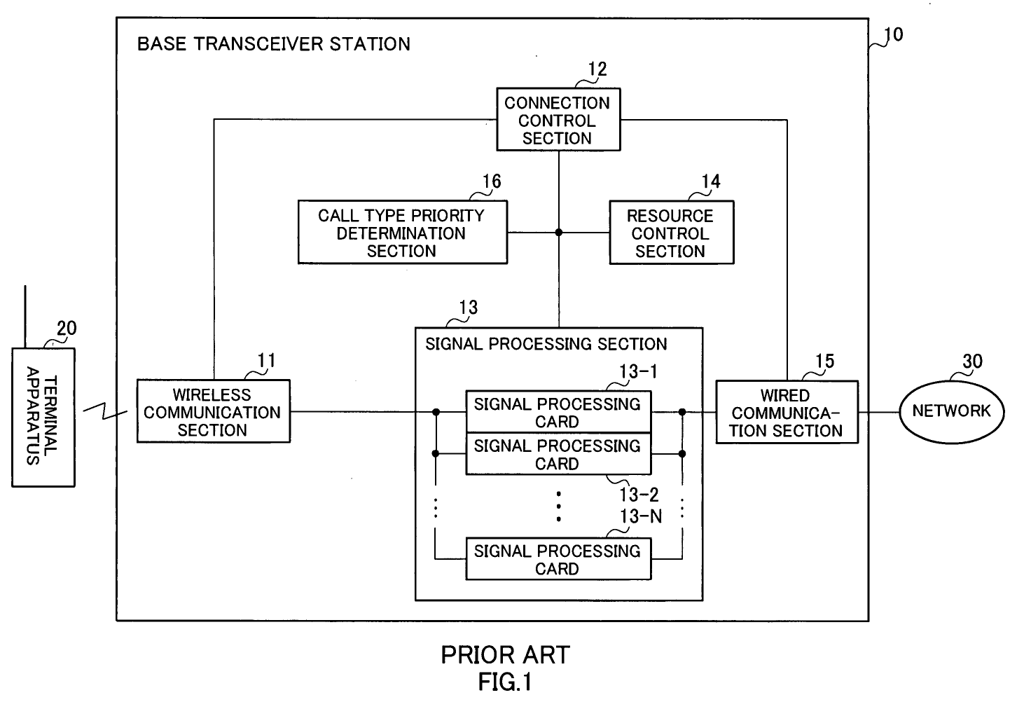

FIG. 2 is a block diagram illustrating a configuration of a base transceiver station according to one embodiment of the present invention;

FIG. 3 is a view illustrating a state of allocation of calls in each of signal processing cards in the base transceiver station according to the one embodiment of the present invention;

FIG. 4A is a flow diagram to explain the first half of resource rearrangement operation in the base transceiver station according to the one embodiment of the present invention; and

FIG. 4B is a flow diagram to explain the latter half of the resource rearrangement operation in the base transceiver station according to the one embodiment of the present invention.

### DESCRIPTION OF THE PREFERRED EMBODIMENT

In an embodiment described specifically below, in order to reduce a degree of mixed existence of a plurality of types of calls in signal processing cards provided in a base transceiver station, types of calls each with a relatively small number of required resources are grouped to A group, while types of calls each with a relatively large number of required resources are grouped to B group. Then, the calls belonging to A group are moved to signal processing cards with small serial numbers, while calls belonging to B group are moved to signal processing cards with large serial numbers, whereby reallocation of calls is performed. By this means, a difference in the number of required resources between call types becomes small when a plurality of types of calls exists together in a signal processing card, and it is thus possible to obtain an effect of suppressing occurrences of call loss due to fragments of available resource.

The reason why the above-mentioned effect is obtained is added herein. In the case where calls each with a large number of required resources exist in a single signal processing card, the signal processing card is capable of accommodating another call with a large number of required resources when any call is deallocated from the signal processing card. Meanwhile, when calls each with a large number of required resources and calls each with a small number of required resources are accommodated in the same signal processing card, it is required to deallocate a large number of calls each with a small number of required resources to enable the signal processing card to accommodate another call with a large number of required resources. Therefore, when aforementioned two cases are compared on the assumption that pending time and occurrence probability are the same over all the types of calls, the latter case has a high possibility of an occurrence of small-area available resource (i.e. fragment occurrence possibility) that cannot accommodate a call with a large number of required resources.

Further, in W-CDMA, it is presumed that packet calls of terminal apparatuses such as cellular telephones are for use in data transmission of several to tens of kilobytes such as, for example, Web access and e-mail. According to an information communication white book of 2002 issued by Japanese Ministry of Public Management, Home Affairs, Posts and Telecommunications, the communication time/the number, of communication times of a cellular telephone exceeded 90 seconds during the years of 1997 to 2000. From the information, it is assumed that actual consecutive data transmission time of a packet call is at most 20 to 30 seconds, while the pending time of a speech call is at least more than 60 seconds. In other words, a speech call tends to remain longer than a packet call with a relatively large number of required resources, and the fragment occurrence possibility is considered to be higher than the above-mentioned case.

The inventor of the present invention noted that an occurrence of a fragment is caused by mixed existence of a plurality of types of calls with different characteristics (for example, the number of required resources), and has reached the present invention. That is why call types and their allocation locations are grouped in this embodiment corresponding to the number of required resources not to cause mixed existence of calls of a plurality of groups.

An embodiment of the present invention will specifically be described below with reference to accompanying drawings.

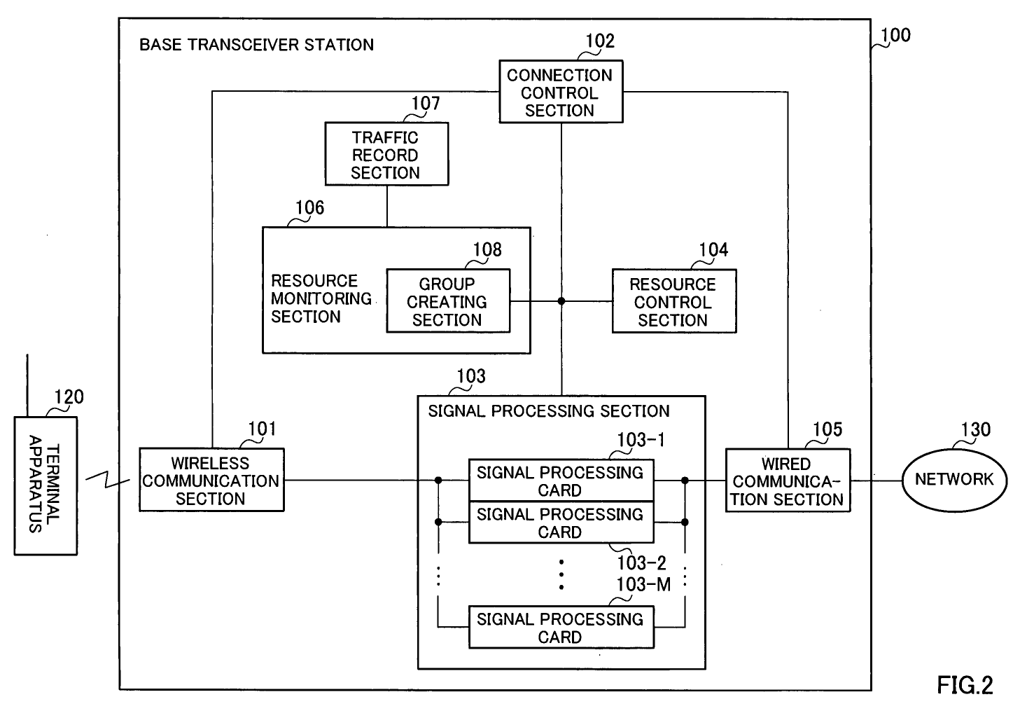

FIG. 2 is a block diagram illustrating a configuration of a base transceiver station according to one embodiment of the present invention.

Base transceiver station 100 as shown in FIG. 2 transmits and receives radio signals to/from terminal apparatus 120, while transmitting and receiving baseband signals for wired communications to/from network 130 with the exchange function, to accommodate communication calls for terminal apparatus 120. In addition, in following descriptions, terminal apparatus 120 is assumed to be a 3rd-generation cellular telephone in W-CDMA or MC-CDMA, but also applicable are portable telephones or cordless telephones in GSM, PHS, PDC or the like. Further, base transceiver station 100 and network 130 connect to each other in ATM via a dedicated channel.

Base transceiver station 100 has wireless communication section 101, connection control section 102, signal processing section 103, resource control section 104, wired communication section 105, resource monitoring section 106 and traffic record section 107. Resource monitoring section 106 has a group creating section 108.

Wireless communication section 101 transmits and receives radio signals to/from terminal apparatus 120. Wireless communication section 101 performs transmit power control of an antenna and terminal apparatus 120, frequency conversion processing and so on. Wireless communication section 101 is provided with the antenna, amplifier, power source for transmission and control program.

Connection control section 102 performs control for connecting and disconnecting a communication path with terminal apparatus 120 in response to a request of network 130. Connection control section 102 is implemented as a program in a control card in base transceiver station 100. Wired communication section 150 transmits and receives signals to/from network 130.

Signal processing section 103 performs predetermined baseband processing such as code modulation processing of radio signals from terminal apparatus 120. In order to accommodate calls of a large number of terminal apparatuses 120 at the same time, signal processing section 103 is provided with a large number of (for example, M) signal processing cards 103-1, 103-2, . . . , 103-M of the same system. Each of signal processing cards 103-1 to 103-M is beforehand assigned a serial number as an identification number. Further, each of signal processing cards 103-1 to 103-M is provided with a unit having a predetermined number of resources to perform predetermined signal processing (baseband processing) on baseband signals of a common channel and call (dedicated channel).

Resource control section 104 allocates and deallocates an occurring call to/from either of signal processing cards 103-1 to 103-M in signal processing section 103. Resource control section 104 reallocates calls according to an instruction from resource monitoring section 106, and thus performs resource rearrangement. Further, using an internal management table, the section 104 manages the number of available resources of each of signal processing cards 103-1 to 103-M. When the processing capability differs for each signal processing card, the number of resources installed in each of signal processing cards 103-1 to 103-M is also managed in the management table.

Resource control section 104 sets the order of signal processing cards 103-1 to 103-M according to serial numbers beforehand assigned to signal processing cards 103-1 to 103-M. In this embodiment, it is assumed that signal processing cards 103-1 to 103-M are respectively assigned numbers of 1 to M, and signal processing cards with smaller serial numbers have higher ranks in the order, while signal processing cards with larger serial numbers have lower ranks in the order. It is also preferable apparently that signal processing cards with larger serial numbers have higher ranks in the order, while signal processing cards with smaller serial numbers have lower ranks in the order.

In addition, the order of signal processing cards 103-1 to 103-M may be set based on the number of available resources managed in the management table. For example, signal processing cards with larger numbers of available resources may have higher ranks in the order, while signal processing cards with small numbers of available resources have lower ranks in the order. It is also preferable that signal processing cards with smaller numbers of available resources have higher ranks in the order, while signal processing cards with large numbers of available resources have lower ranks in the order.

Resource monitoring section 106 monitors a state of each of signal processing cards 103-1 to 103-M in signal processing section 103, and judges whether or not to need resource rearrangement. For example, the judgment is made by determining whether or not the number of signal processing cards, in which a plurality of types of calls belonging to different groups exists together, is not less than a predetermined number. When resource rearrangement is needed, resource monitoring section 106 instructs resource control section 104 to reallocate a call allocated to either of signal processing cards 103-1 to 103-M.

In addition, the predetermined number that is a criterion by which to judge whether or not to need resource rearrangement may be varied corresponding to the total number of used resources in signal processing section 103. This is because cancellation of mixed existence in a signal processing card is not easy when the traffic volume is large. Accordingly, for example, the predetermined number may be set at “1” when the total number of used resources is less than a certain number, while being set at “2” when the total number of used resources is more than or equal to the certain number. It is thus possible to perform adaptive resource management in response to the traffic volume.

Traffic record section 107 records past traffic therein.

Group creating section 108 compares the number of required resources of each of all the types of calls with a predetermined threshold, and sorts to A group calls each with the number of required resources less than or equal to the predetermined threshold, while sorting to B group calls each with the number of required resources more than the predetermined threshold. In addition, in this embodiment the number of groups is two to reduce loads of rearrangement processing. However, it is possible to achieve the effect of reducing the fragment occurrence probability also in the case of three groups.

For example, with respect to the number of required resources, it is assumed that a speech call has one area, UDI call has three areas, a low-rate packet call has six areas, and that a high-rate packet call has sixteen areas. When the threshold is three, speech calls and UDI calls belong to A group, while low-rate packet calls and high-rate packet calls belong to B group. In addition, types of calls to support are not limited to the above-mentioned types, and may vary with providers that provide communication services.

Further, group creating section 108 may vary the threshold corresponding to details recorded in traffic record section 107. For example, the section 108 sets a threshold such that only high-rate packet calls belong to B group when only high-rate packets calls are large in number, while setting a threshold such that low-rate packet calls also belong to B group when the number of low-rate packets calls increases. Thus performing grouping dynamically enables resource rearrangement corresponding to the state of traffic.

Furthermore, this embodiment aims to sort calls where significant fragmentation is not apt to occur to A group, while sorting calls where significant fragmentation is apt to occur to B group. Therefore, a call with long pending time among calls belonging to B group may be changed to A group. In this case, it is possible to reduce calls having remained for a long period in a signal processing card with a large serial number (lower-ranked signal processing card) to mainly accommodate calls belonging to B group (calls each with a relatively large number of required resources). Particularly, it is possible to reduce the probability that a fragment occurs in a signal processing card with a larger serial number. The similar operation effect is implemented also by adopting a method of determining a group based on the pending time estimated from the content of the record of past traffic.

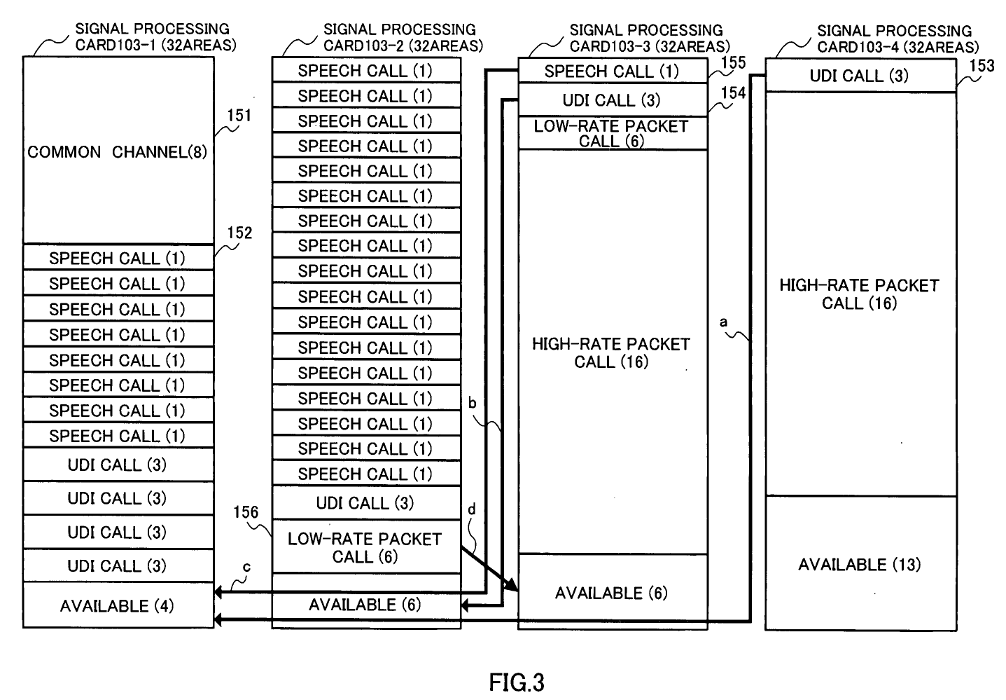

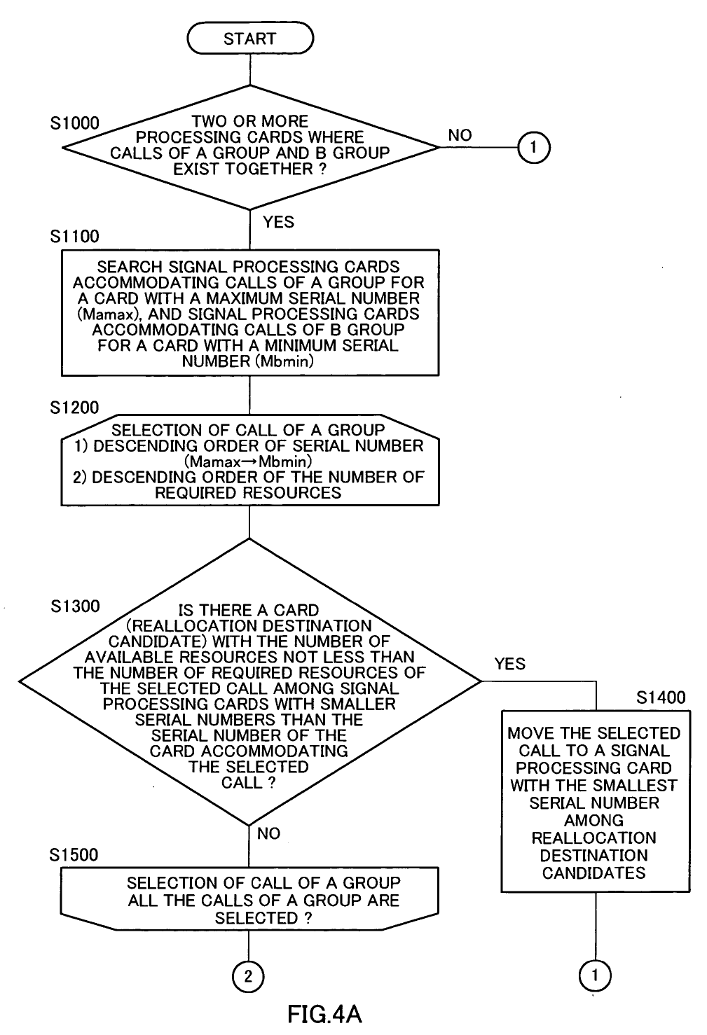

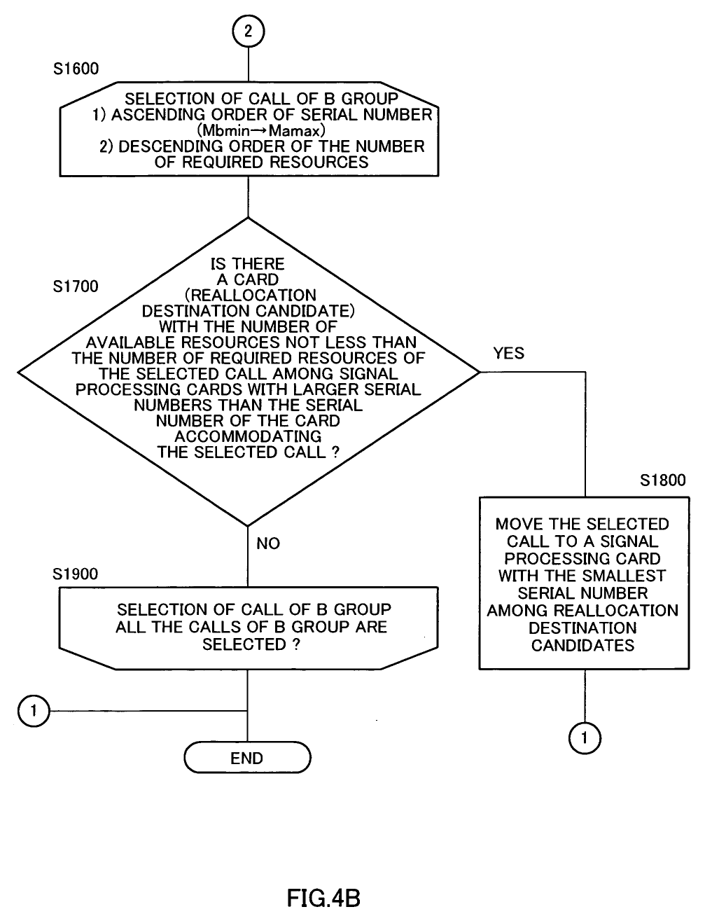

The operation in base transceiver station 100 with the above-mentioned configuration will be described below. FIG. 3 is a view illustrating a state of allocation of calls in each of signal processing cards 103-1 to 103-M in base transceiver station 100, FIGS. 4A and 4B are flow diagrams to explain the resource rearrangement operation in base transceiver station 100.

A state of allocation and allocation operation prior to resource rearrangement will be described below with reference to FIG. 3. As a premise condition in following descriptions, it is assumed that M is four (M=4), i.e. the number of signal processing cards in base transceiver station 100 is four. Further, the number of resources of each of signal processing cards 103-1 to 103-M is predetermined. Although it is not necessary for each of signal processing cards 103-1 to 103-M to have the same number of resources, in this embodiment each of signal processing cards 103-1 to 103-M is assumed to have resources of 32 areas. In other words, assuming that each of signal processing cards 103-1 to 103-M has the baseband processing capability of 768 kbps, a resource of one area corresponds to the baseband processing capability of 24 kbps.

Common channel 151 is a channel for paging terminal apparatus 120, and reserved immediately after startup of base transceiver station 100. In this embodiment, common channel 151 is allocated to signal processing card 103-1. As common channel 151, for example, there are BCH (Broadcast CHannel), FACH (Forward Access CHannel), RACH (Random Access CHannel), and PCH (Paging CHannel). The number of required resources of common channel 151 increases or decreases corresponding to the size of a coverage area and the number of available channels of base transceiver station 100, but is herein assumed to be 8 areas. A number inside each parenthesis in FIG. 3 is the number of required resources.

For example, as shown in FIG. 3, various kinds of calls are allocated to each of signal processing cards 103-1 to 103-M. For example, in addition to common channel 151, signal processing card 103-1 is assigned a dedicated channel for speech call 152 to accommodate speech call 152 and another dedicated channel. At the current time, the numbers of available resources in signal processing cards 103-1 to 103-M are four areas, six areas, six areas and thirteen areas, respectively. At this point, when UDI call 153 is deallocated or reallocated to another signal processing card, the number of available resources in signal processing card 103-4 becomes thirteen plus three (=16) areas.

The allocation of calls (dedicated channels) is carried out as described below. First, when terminal apparatus 120 enters a coverage area of base transceiver station 100, position registration and ATTACH (processing for making a state where terminal apparatus 120 is capable of receiving an incoming call from network 130) is performed to network 130. In addition, resources in base transceiver station 100 are used in ATTACH of terminal apparatus 120, and also in this case, it is possible to implement the effects of the present invention. However, for simplicity in descriptions, resources used in ATTACH are not considered in this embodiment.

After position registration of terminal apparatus 120, for example, when terminal apparatus 120 issues speech call 152, base transceiver station 100 establishes transmission paths for use in call connection between terminal apparatus 120 and network 130. As a result, one area of resource in signal processing card 103-1 is used for baseband processing of speech call 152.

Procedures for call allocation will be described below using allocation of speech call 152 of terminal apparatus 120 as an example. First, terminal apparatus 120 outputs an issue request to network 130 via base transceiver station 100 using common channel 151. Inside base transceiver station 100, wireless communication section 101 receives the request, performs frequency conversion, etc. and outputs a result of the processing to signal processing section 103. Signal processing section 103 performs the baseband processing in signal processing card 103-1, and outputs a result of the processing to wired communication section 105. Wired communication section 105 performs protocol conversion processing or the like on the input signal, and outputs a result of the processing to network 130. In this embodiment, base transceiver station 100 is only controlled by network 130, and not controlled by signal from terminal apparatus 120. In addition, the algorithm of the present invention is not related to a trigger of resource allocation processing, and therefore, it is possible to implement the effects of the present invention also in the case where the resource allocation processing is controlled by signal from terminal apparatus 120.

Then, in response to the issue request, network 130 outputs a request to reserve resources for speech call 152 of terminal apparatus 120 to base transceiver station 100. The output resource reserve request is input to wired communication section 105. Since the resource reserve request is a control request to base transceiver station 100, connection control section 102 detects the request. Connection control section 102 outputs to resource control section 104 a request to reserve resources for speech call 152 in signal processing section 103. Resource control section 104 refers to a management table of signal processing section 103. Herein, the section 104 finds available resources in signal processing card 103-1, and allocates speech call 152 to the card 103-1. After allocating the speech call, the section 104 updates the number of available resources in the management table.

As a method of selecting a signal processing card as a call allocation destination, there are considered a method of selecting signal processing cards with sufficient available resources in descending or ascending order of serial number, a method of selecting the cards in descending or ascending order of the number of available resources, and so on. Although in any case of using either of the methods it is possible to implement the same operation effects in base transceiver stations to which the resource rearrangement of the present invention is applied, this embodiment adopts the method of allocating calls belonging to A group to signal processing cards of small serial numbers with available resources, while allocating calls belonging to B group to signal processing cards of large serial numbers with available resources. By combining such an allocation method with the resource rearrangement method of the present invention, at the time of allocating a call, it is possible to allocate the call to a position (i.e. signal processing card) such that mixed existence of calls of the first and second groups is apt not to occur. Therefore, it is possible to reduce the need of execution of call reallocation, decrease processing loads on base transceiver station 100, and further decrease the probability of occurrence of a fragment.

After performing call allocation as described above, connection control section 102 outputs a response signal in response to the resource reserve request to network 130 via wired communication section 105. The communication path is thus established from terminal apparatus 120 to network 130.

Further, when the call ends, after processing for disconnecting the call on an upper layer, network 130 outputs to base transceiver station 100 a resource deallocation request including designation of the call subject to deallocation. Upon detecting the request, connection control section 102 outputs a request for deallocating the resource to resource control section 104. Resource control section 104 specifies the signal processing card subject to deallocation, instructs signal processing section 103 to deallocate the call, and updates the number of available resources of the signal processing card in the internal management table.

The resource rearrangement operation in base transceiver station 100 will be described below with reference to FIGS. 4A and 4B.

The resource rearrangement operation specifically described herein is executed, for example, at the time of call deallocation or after a lapse of predetermined time.

In step S1000, resource monitoring section 106 determines the degree of mixed existence of calls of A group and calls of B group. More specifically, the section 106 counts the number of signal processing cards where calls of A groups and calls of B group are mixed to exist, and determines whether the count number is not less than a predetermined number (herein, two). When a result of the determination shows a case of one signal processing card with the mixed existence occurring (S1000: NO), the case is interpreted that the possibility of occurrence of a fragment is relatively low, and the resource rearrangement operation is finished. Meanwhile, in a case of two or more signal processing cards with the mixed existence occurring (S1000: YES), the processing flow proceeds to step S1100.

In step S1100, resource control section 104 searches signal processing cards that accommodate calls of A group (speech calls and UDI calls) for a signal processing card with a maximum serial number (Mamax) and further searches signal processing cards that accommodate calls of B group (high-rate packet calls and low-rate packet calls) for a signal processing card with a minimum serial number (Mbmin). For example, in the example as shown in FIG. 3, since a signal processing card with the maximum serial number is signal processing card 103-4 among the signal processing cards that accommodate calls of A group, Mamax is four (Mamax=4). Meanwhile, since a signal processing card with the minimum serial number is signal processing card 103-2 among the signal processing cards that accommodate calls of B group, Mbmin is two (Mbmin=2).

Then, in step S1200, resource control section 104 starts loop processing for selecting a call of A group. In the loop processing, the section 104 selects, one by one, calls of A group allocated to signal processing cards with serial numbers of Mamax to Mbmin. Calls are selected in descending order of serial number, and in the signal processing card with the same serial number, calls are selected in descending order of the number of required resources. In the example of FIG. 3, a call of A group first selected is UDI call 153 allocated to signal processing card 103-4.

By preferentially selecting a call with a large number of required resources as a call targeted for reallocation in the processing of step S1200, it is possible to make resource rearrangement efficient.

Then, in step S1300, resource control section 104 searches signal processing cards with smaller serial numbers than the serial number of the card accommodating the selected call for a signal processing card (reallocation destination candidate) with the number of available resources more than or equal to the number of required resources of the selected call, and determines the presence or absence of such a card. In the example of FIG. 3, when UDI call 153 is selected, signal processing cards 103-1 to 103-3 correspond to reallocation designate candidates. In the processing, when one or more reallocation destination candidates are retrieved (S1300: YES), in step S1400, resource control section 104 moves the selected call to a signal processing card with the smallest serial number among the reallocation destination candidates, and finishes the operation. In the example of FIG. 3, since signal processing card 103-1 is the signal processing card with the smallest serial number among the reallocation destination candidates, as shown by arrow a, UDI call 153 is moved to signal processing card 103-1. As a result of such moving processing, the number of available resources of signal processing card 103-4 increases from thirteen areas to sixteen areas, while the number of available resources of signal processing card 103-1 decreases from four areas to one area.

Meanwhile, in the processing of S1300, when one or more reallocation destination candidates are not retrieved (S1300: NO), for example, because the traffic volume is large, in step S1500, resource control section 104 determines whether or not all the calls of A group have been selected. As a result of the determination, when there is a call of A group that is not selected, the processing flow returns to step S1200, while proceeding to step S1600 when all the calls have been selected already.

By repeating the operation of above-mentioned steps S1200 to S1500, in the example of FIG. 3, subsequent to UDI call 153, UDI call 154 allocated to signal processing card 103-3 is moved to signal processing card 103-2 as shown by arrow b, and further, speech call 155 allocated to signal processing card 103-3 is moved to signal processing card 103-1 as shown by arrow c.

As described in steps S1200 to 1500, in this embodiment, preferentially moved are calls of A group that are allocated to signal processing cards with large serial numbers (lower ranked signal processing cards) to mainly accommodate calls of B group. There are two reasons. One is that calls belonging to B group have a relatively large number of required resources, and therefore, the fragment occurrence probability of signal processing cards with large serial numbers to mainly accommodate B group is higher than that of signal processing cards with small serial numbers. The other one is that calls of A group have smaller numbers of required resources than those of B group, and so, are easy to move. Accordingly, by preferentially handling calls of A group as compared with calls of B group, it is possible to efficiently avoid the mixed existence.

In step S1600, resource control section 104 starts loop processing for selecting calls of B group. In the loop processing, the section 104 selects, one by one, calls of B group allocated to signal processing cards with serial numbers of Mbmin to Mamax. Calls are selected in ascending order of serial number, and in the signal processing card with the same serial number, calls are selected in descending order of the number of required resources. In the example of FIG. 3, a call of B group first selected is low-rate packet call 156 allocated to signal processing card 103-2.

By preferentially selecting a call with a large number of required resources as a call targeted for reallocation in the processing of step S1600, it is possible to make resource rearrangement efficient.

Then, in step S1700, resource control section 104 searches signal processing cards with larger serial numbers than the serial number of the card accommodating the selected call for a signal processing card (reallocation destination candidate) with the number of available resources more than or equal to the number of required resources of the selected call, and determines the presence or absence of such a card. In the example of FIG. 3, when low-rate packet call 156 is selected, signal processing cards 103-3 to 103-4 correspond to reallocation destination candidates. In the processing, when one or more reallocation destination candidates are retrieved (S1700: YES), in step S1800, resource control section 104 moves the selected call to a signal processing card with the smallest serial number among the reallocation destination candidates, and finishes the operation. In the example of FIG. 3, since signal processing card 103-3 is the signal processing card with the smallest serial number among the reallocation destination candidates, as shown by arrow d, low-rate packet call 156 is moved to signal processing card 103-3.

In this embodiment, in the processing of step S1800, calls of B group are also reallocated to signal processing cards with small serial numbers as possible, and therefore, it is possible to reserve available resources on the side of the maximum serial number among signal processing cards with large serial numbers to mainly accommodate calls of B group. It is thus possible to more assuredly accommodate a call of B group with a relatively large number of resources.

Meanwhile, in the processing of S1700, when one or more reallocation destination candidates are not retrieved (S1700: NO), for example, because the traffic volume is large, in step S1900, resource control section 104 determines whether or not all the calls of B group have been selected. As a result of the determination, when there is a call of B group that is not selected, the processing flow returns to step S1600, while the rearrangement operation is finished when all the calls have been selected already.

In addition, in this embodiment, resource rearrangement is carried out according to groups to which calls are sorted. Therefore, for example, whenalow-rate packet call is moved to a signal processing card with available resources capable of accommodating a high-rate packet call, as a result of such moving, a possibility slightly arises that the signal processing card is not able to accommodate a high-rate packet call, and a fragment is induced. In order to prevent such a phenomenon, before moving a call targeted for reallocation, it is determined whether a sum of a square of available resources of a signal processing card of a moving source and a square of available resources of a signal processing card of a moving destination decreases or not due to execution of moving. As a result of the determination, for example, when a high-rate packet call cannot be accommodated in the above-mentioned example, resource control section 104 may perform processing for canceling the moving processing. Also in the case of combining such processing with the resource rearrangement operation as described above, it is possible to obtain the effect of suppressing occurrences of a fragment.

Thus, according to this embodiment, A group includes calls each with a number of required resources less than or equal to a threshold, while B group includes calls each with a number of required resources more than the threshold, and reallocation of calls is performed according to the groups. It is thereby possible to avoid calls of B group and calls of A group existing together in each of signal processing cards 103-1 to 103-M, and reduce the probability of occurrence of a fragment. It is thus possible to increase the resource use efficiency of signal processing cards 103-1 to 103-M, while suppressing occurrences of call loss, and to increase the number of calls that can be accommodated at the same time.

Further, according to this embodiment, ranks of signal processing cards 103-1 to 103-M are beforehand set. When an allocated call is sorted to A group, the call is moved to a signal processing card with a higher rank than that of another signal processing card to which the call is allocated. Meanwhile, when an allocated call is sorted to B group, the call is moved to a signal processing card with a lower rank than that of the signal processing card to which the call is allocated. It is thus possible to move a call of A group and a call of B group in the inverse direction. Accordingly, even when the mixed existence of a call of A group and a call of B group has occurred already at the time of allocating a call to connect, it is possible to move the call in the direction enabling avoidance of the mixed existence, and to assuredly decrease the fragment occurrence probability.

The base transceiver station and the resource rearrangement method of the present invention have the effect of increasing the number of calls that can be accommodated at the same time, and are effective as a base transceiver station enabling wireless communications with a plurality of terminal apparatuses and a resource rearrangement method applied to such a base transceiver station.

The present invention is not limited to the above described embodiment, and various variations and modifications may be possible without departing from the scope of the present invention.

This application is based on the Japanese Patent Application No.2003-384721 filed on Nov. 14, 2003, the entire content of which is expressly incorporated by reference herein.

1. A base transceiver station comprising:
a plurality of signal processors each of which has a predetermined number of resources to perform predetermined signal processing on a call;
a sorter which compares the number of required resources of a call with a predetermined value, and sorts the call to a group corresponding to a result of comparison; and
an allocating section that allocates a call to connect to a single signal processor among the plurality of signal processors,
wherein the allocating section reallocates the call to another signal processor of the plurality of signal processors according to the group to which the call is sorted that is allocated to the single signal processor.

2. The base transceiver station according to claim 1, wherein the sorter sorts a call with a number of required resources less than or equal to the predetermined value to a first group, while sorting a call with a number of required resources more than the predetermined value to a second group, and
the allocating section beforehand sets ranks of the plurality of signal processors according to identification numbers beforehand assigned respectively to the plurality of signal processors, and when an allocated call is sorted to the first group, moves the call to a signal processor with a higher rank than that of the single signal processor, while when an allocated call is sorted to the second group, moving the call to a signal processor with a lower rank than that of the single signal processor, thus performing reallocation of the call.

3. The base transceiver station according to claim 2, wherein the allocating section searches the plurality of signal processors for a signal processor with the number of available resources more than or equal to the number of required resources of the call to connect, and when the call is sorted to the first group, allocates the call to a signal processor with the highest rank among retrieved signal processors, while when the call is sorted to the second group, allocating the call to a signal processor with the lowest rank among retrieved signal processors.

4. The base transceiver station according to claim 3, wherein the sorter moves to the first group a call with pending time more than a predetermined period among calls sorted to the second group.

5. The base transceiver station according to claim 3, wherein when the allocated call is sorted to the second group, the allocating section searches signal processors with lower ranks than that of the single signal processor for a signal processor with the number of available resources more than or equal to the number of required resources of the call, moves the call to a signal processor with the highest rank among retrieved signal processors, and thereby performs reallocation of the call.

6. A resource rearrangement method in a base transceiver station having a plurality of signal processors each having a predetermined number of resources to perform predetermined signal processing on a call, comprising:
a sorting step of comparing the number of required resources of a call with a predetermined value, and sorting the call to a group corresponding to a result of comparison;
an allocating step of allocating a call to connect to a single signal processor among the plurality of signal processors; and
a reallocating step of reallocating the call to another signal processor of the plurality of signal processors according to the group to which the call, which is allocated to the single signal processor in the allocating step, is sorted in the sorting step.
